(19) United States
(12) Patent Application Publication
(10) Pub. No.: US 2008/0223563 A1
(43) Pub. Date: Sep. 18, 2008

(54) U Shaped Cooler

(76) Inventors: Charles Penny, Ross-on-Wye (GB); Claire Nash, Newport (GB); Michael Taylor, Monmouthshire (GB); Steven Fairhurst, Gwent (GB); Paul Downs, Gwent (GB)

Correspondence Address: GREENBERG TRAURIG, LLP, 77 WEST WACKER DRIVE, SUITE 2500, CHICAGO, IL, 60601-1732, US

(21) Appl. No.: 12/048,827

(22) Filed: Mar. 14, 2008

(30) Foreign Application Priority Data
Mar. 17, 2007 (GB) 0705166.7

(51) Int. Cl. F28F 3/04; F28D 7/06; B23P 15/26

(52) U.S. Cl. 165/166; 165/164; 29/890.035

(57) ABSTRACT

An exhaust gas re-circulation cooler device comprises at least one cooling plate, said cooling plate comprising an upper plate wall and a lower plate wall; said upper and lower plate walls defining a plurality of gas passages which have a gas inlet at a first end of cooling plate and a gas outlet at said first end of said cooling plate; each said passage directing a gas flow between said inlet and said outlet and along a length of said plate; and said plate being sealed so as to be gas tight along a length of said plate, and at a second end of said plate.

### FIELD OF THE INVENTION

The present invention relates to gas heat exchangers, and particularly, although not exclusively, to exhaust gas re-circulation coolers for use in automotive applications.

### BACKGROUND TO THE INVENTION

There are many applications in which it is desirable to use gas heat exchangers. These include applications where it is desirable to cool down a gas, for example, in exhaust gas re-circulation (EGR) coolers. Further, there are applications where a hot gas inlet and a cooled gas outlet need to be in close proximity, due to space constraints.

Under some circumstances, heat exchange may be required, but under other circumstances it may be undesirable. For example, in cold engine conditions, it may be desirable not to cool the gas in order to aid more rapid heating of the engine, but under hot engine conditions, it may be desirable to cool the gas. Such an application includes an exhaust gas re-circulation circuit.

Exhaust gas re-circulation is a method of reducing noxious emissions from internal combustion engines. In particular, the presence of exhaust gas in the combustion mixture reduces the percentage of oxygen and thus reduces the tendency to form NOX compounds.

In general, it is advantageous to cool the re-circulated exhaust gas, since its reduced temperature helps to lower the combustion temperature within the engine cylinders. Further, since gas becomes more dense when cooled, for a given pressure drop across the exhaust gas re-circulation system, more gas can be passed through the system using cool gas, compared to hot gas.

However, cooling the exhaust gas is not desirable under all conditions. When the engine temperature is low or the engine is under low loading, it is often preferable to re-circulate the exhaust gas without cooling. With more advanced engines, it can be beneficial to control the re-circulated exhaust gas temperature. In this case, some of the gas will be cooled and some will be un-cooled such that the mixture of the two can give a desired overall gas temperature.

Consequently, many applications, which require a heat exchanger, also require a gas bypass so that passing the gas through the heat exchanger for cooling is selectable. When cooling the gas is required, a bypass valve is closed, and the gas passes through heat exchanger. When cooling of the gas is undesirable, the bypass is opened, so that the gas bypasses the heat exchanger.

If it is required to control the temperature of the gas outlet, the bypass valve can be used to partially route a gas flow through the heat exchanger, so that an un-cooled bypass flow which bypasses the heat exchanger altogether, is mixed with a cooled gas flow which passes through the heat exchanger, giving a blended gas flow of part un-cooled and part cooled gas.

Consequently, if gas outlet temperature control is required, a bypass valve can be operated in the partially open condition.

Within a conventional heat exchanger, a coolant conduit and a gas conduit are generally in close proximity, typically separated by a thin wall which acts as a heat energy conductor between the coolant and the gas. When gas cooling is required, then the gas is diverted to be carried by the gas cooling conduit. Under circumstances where gas cooling is not required, then the gas is diverted through the bypass conduit.

A bypass valve controls whether the gas is carried in the gas cooling conduit or in the bypass conduit. For current EGR applications, the bypass valve is separated from the EGR valve, which controls the volume of re-circulated exhaust gas.

When gas is being transported through the bypass conduit, it is undesirable for the gas to be cooled. To achieve this there should be as little contact as possible between the bypass conduit and the coolant conduit, since coolant fluid in the coolant conduit would cool gas that is transported through the bypass conduit under bypass conditions.

### SUMMARY OF THE INVENTION

In an embodiment of the invention, an exhaust gas re-circulation cooler device comprises at least one cooling plate, said cooling plate comprising an upper plate wall and a lower plate wall. The upper and lower plate walls define a plurality of gas passages which have a gas inlet at a first end of cooling plate and a gas outlet at said first end of said cooling plate. Each passage directs a gas flow between said inlet and said outlet and around a length of said plate. The plate is sealed so as to be gas tight along a length of said plate, and at a second end of said plate.

In another embodiment of the invention, a cooling plate for a cooling device comprises a first side wall and a second side wall, said first and second side walls being spaced apart from each other. The first and second side walls are connected at an upper and a lower portion. The cooling plate has a first end comprising one or a plurality of openings for entry of a gas, and a second end, which is closed off. A plurality of gas conduits are arranged side by side, each gas conduit extending from an inlet portion at the first end of the plate, to an outlet portion at said first end of the plate.

The invention also comprises a method of manufacture of a cooling plate for a gas cooling device. The method comprises the steps of:

forming first and second opposed sides spaced apart form each other, wherein said first and second sides define a plurality of gas conduits arranged side by side between said first and second sides, each said gas conduit extending from an inlet portion at a first end of said cooling plate to an outlet portion at said second end of said cooling plate; and

sealing said first and second sides at a second end, opposite to said first end, to form a gas tight seal between said first and second sides.

The invention also comprises a method of manufacture of a cooling device, in which the cooling device comprises:

at least one cooling plate, said cooling plate comprising:

an upper plate wall and a lower plate wall

said upper and lower plate walls defining a plurality of gas passages which have a gas inlet at a first end of cooling plate and a gas outlet at said first end of said cooling plate;

each said passage directing a gas flow between said inlet and said outlet and around a length of said plate;

said plate being sealed so as to be gas tight along a length of said plate, and at a second end of said plate; and

an outer canister for containing said at least one cooling plate, and for containing a flow of coolant fluid around said at least one cooling plate,

wherein the method comprises the steps of:

inserting said cooling plate into said canister such that one or a plurality of gas inlet ports and one or a plurality of gas outlet ports positioned at a first end of said cooling plate are positioned at a first end of said canister; and

connecting said first end of said cooling plate to said first end of said canister such that said gas passages are contained within said canister and said plurality gas inlets and gas outlets are accessible at said first end of said canister.

The invention also comprises an exhaust gas re-circulation cooler device comprising:

at least one cooling plate, said cooling plate comprising:

first and second walls;

said first and second walls defining a plurality of gas passages which have a gas inlet at a first end of said cooling plate and a gas outlet at said first end of said cooling plate;

each said passage directing a gas flow between said inlet and said outlet and along a length of said plate;

said plate being sealed so as to be gas tight along a length of said plate, and at a second end of said plate,

wherein thermal growth of said cooling plate is accommodated predominantly in a plane of the gas passages.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a “U” shaped cooler according to an embodiment of the present invention in perspective view from one end and one side;

FIG. 2 illustrates schematically a plurality of stacked cooling plates of the U shaped cooler of FIG. 1 herein;

FIG. 3 illustrates schematically an individual cooling plate of the U shaped cooler of FIGS. 1 and 2;

FIG. 4 illustrates schematically in partial cut away view from above the U shaped cooler of FIGS. 1 to 3 herein;

FIG. 5 illustrates an embodiment in side section, showing a gas path within the first embodiment coolant plate of the U shaped cooler;

FIG. 6 illustrates schematically a second and alternative gas path within another embodiment plate of the U shaped cooler of FIGS. 1 to 4;

FIG. 7 illustrates schematically 3 dimensions of gas flow throughout a cooler plate of the U shaped cooler of FIGS. 1 to 5;

FIG. 8 further illustrates schematically in three dimensions the movement of gas flow within a plate of the U shaped cooler described herein;

FIG. 9 illustrates schematically the embodiment of the U shaped cooler of FIGS. 1 to 4 herein, in cut away view, showing a flow paths of coolant around a plurality of parallel stacked cooling plates, within the U shaped cooler of FIGS. 1 to 8 herein;

FIG. 10 illustrates schematically a length of hollow cylindrical tube used in a method of manufacture of a cooling plate;

FIG. 11 illustrates schematically a plurality of cooling plates in a partially formed state; and

FIG. 12 illustrates schematically in plan view, a pair of cooling plates formed from a single length of metal tube during a stage of manufacture.

### DETAILED DESCRIPTION

In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Specific embodiments according to the present invention aim to utilize the positive features of a plate type U shaped cooler whilst addressing the design and manufacture problems of known plate type U shaped coolers.

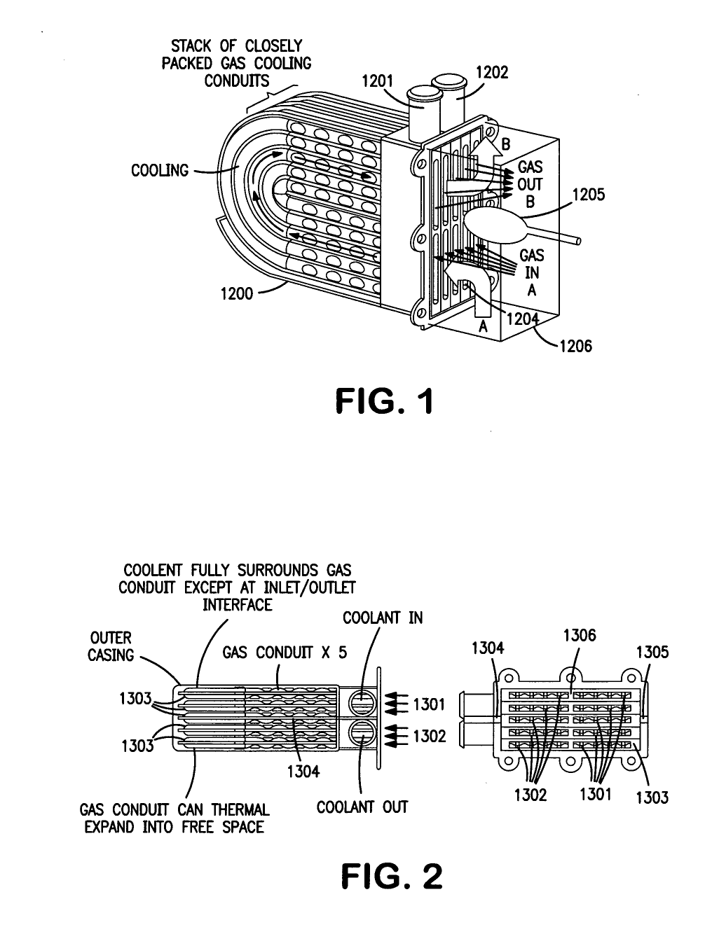

Referring to FIG. 1 herein, there is illustrated schematically a “U” shaped cooler according to a first specific embodiment of the present invention. The cooler comprises a “U” shaped canister 1200 having an inlet port 1201 for inlet of cooling fluid and an outlet port 1202 for outlet of the cooling fluid, such that the cooling fluid can flow throughout the canister 1200, and internally of the canister; and one or a plurality of cooling plates, each cooling plate comprising a plurality of cooling channels through which a gas may be passed. The canister may be constructed from a single component or from a plurality of components. The one or plurality of cooling plates are attached to the canister directly or via a connector plate at or near the region of the inlet and outlet ports through which gases flow into the U shaped cooler, and are exhausted out of the U shaped cooler. The cooler may be connected to a gas flow tube 1203, which contains a gas bypass valve, which is actuable via a protruding external shaft 1204. An electrical or vacuum operated actuator mechanism may be attached to the shaft 1204 for electrically actuating the bypass valve within the cooling tube either to pass incoming gas through the U shaped cooler, or to bypass the gas from the U shaped cooler altogether.

The cooler and gas flow tube may be welded or brazed together to form a compact unit. The gas flow tube is provided with a plurality of flanges 1205, 1206, one at each end of the tube, for fitting the tube into a gas flow path of a combustion engine, or other gas flow system, where cooling of the gas may be selectively required.

The coolant inlet and outlets 1201, 1202 are shown in FIG. 1 as being on a same side of the U shaped cooler. However, in other embodiments, the inlet 1201 may be positioned on an opposite side of canister to the outlet 1202. Alternatively, the inlet 1201 and the outlet 1202 may be positioned in any location around the canister, but remaining the same distance from the first end of the gas conduits.

In use, gas flowing through the gas flow tube 1203 in a direction A-B as shown by the arrows may be directed by the bypass valve 1204, through the U shaped cooler, entering the cooler at the bottom, and passing into the curved periphery of the “U” shaped canister and returning to exit at the top of the cooler and then out of the gas flow tube. Alternatively, where the bypass valve is actuated to bypass the cooler, then the gas flow A-B flows straight through the gas flow tube without entering the cooler. Of course, if the cooler is inverted, then the gas flow would enter at the top of the cooler, and exhaust out of the bottom of the cooler. Further, if the gas flow were reversed, then the gas may enter the top of the cooler and exhaust through the bottom of the cooler, so that orientation of the U shaped cooler relative to the gas flow can be reversed, without any significant difference in cooling operation.

Where the gas bypass valve is placed at an intermediate setting, so that it directs some gas through the cooler and some gas directly from the gas flow tube inlet to the gas flow tube outlet, then a partial cooling of the gas flow may result.

Referring to FIG. 2 herein, there is illustrated the U shaped cooler in cut away view. The cooler is formed from a stack of closely packed gas cooling conduits 1300. Each gas cooling conduit individually forms a complex sealed gas path from an inlet of the gas cooling device to an outlet of the gas cooling device and places a plurality of gas inlets 1301 adjacent to each other and a plurality of gas outlets 1302 adjacent to each other.

Each conduit is formed in a plate-like structure, an exterior surface of which is exposed to coolant fluid within the coolant canister 1200, which flows around and between the plates, and the interior of which is exposed to the gas flow. The plurality of plates are connected to each other at one end of the cooler, by being welded or soldered either to each other and the canister, or to a connector plate 1303. A pair of spacers 1304, 1305, respectively, may be fitted to the straight edges of the single or centermost cooling plate. The spacers 1304, 1305 serve as a guide for positioning and locating the outer canister 1200, so that the plurality of cooling plates lie within the canister, spaced apart from the edges of the canister, so that each of the cooling plates does not come into direct contact with the canister, there being enough space for passage of coolant fluid between the cooling plate and the canister wall. This has the advantage that as the cooler heats up and cools down, and the canister and cooling plates experience thermal expansion or contraction, because the cooling plates are not physically abutting the canister walls, there are fewer physical stresses due to expansion or cooling, between the cooling plates and the canister wall. The spacers can also act as coolant barriers to direct flow from the coolant inlet spigot to the return end of the cooler and back to the coolant outlet spigot.

Alternatively, the canister can have a form such that it closes the coolant gap between the canister and the single center most gas conduit.

There may however be thermal stresses between the ends of the cooling plates 1300, and the canister at the gas inlet/outlet face and, if fitted, the connector plate 1303 to which the cooling plates are brazed or welded, as the device heats up and cools down in use.

The open end of the cooling plate or plates or the connector plate 1303 form an inlet/outlet manifold for entry of gas into the plurality of cooling plates, and for exit of gas out of the plurality of cooling plates. An inlet port 1301 is formed by one or a plurality of inlets to one or a plurality of corresponding respective coolant plates as shown in FIG. 2. An outlet port is formed by one or a plurality of adjacent cooling plate outlets and if fitted joined to the connecting plate 1303 as shown in FIG. 2. If fitted, the connecting plate 1303 may form one side of a gas flow tube as shown in FIG. 1 herein. The gas flow tube may be welded or brazed to either side of the connecting plate 1303.

If fitted, the connecting plate 1303 in the embodiment shown comprises a rectangular plate having a pair of rectangular cut outs, one for the gas outlet, and one for the gas inlet. A bridge portion 1306 that may be part of the connecting plate, or if the connecting plate is not fitted, a separate component between the gas outlet and inlet portions, provides a mating surface for meeting with a gas bypass valve within the gas flow tube. The gas bypass valve, in its simplest form, can be a butterfly-type valve consisting of a plate, having a central pivotal axis, which can be actuated externally from the gas flow tube.

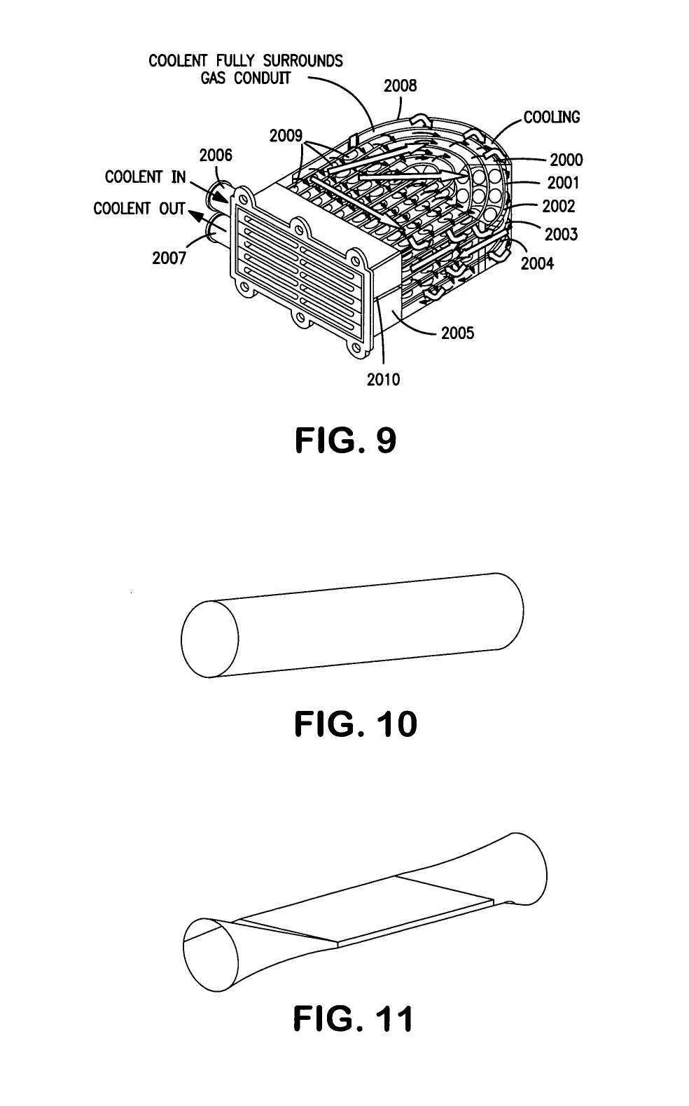

Referring to FIG. 8 herein, there is illustrated schematically a single cooling plate in partial cut away view as seen from one side. Referring to FIG. 9, a plurality of gas cooling conduits 2000-2004 are enclosed by an outer casing which, together with an outer surface of the gas cooling conduit, forms a coolant conduit. The whole assembly comprises a modular channeled U shaped cooler.

Each individual gas conduit follows a substantially “U” shaped path, having first and second parallel portions, connected by a semicircular return portion. The straight portions of an outer gas conduit 1900 are spaced apart from each other by a distance, which is almost a full height of the gas cooling plate. An immediately adjacent first inner gas cooling conduit 1901 nests within the outer gas cooling conduit 1900, laying parallel thereto and in a main plane of the cooling plate. Similarly, a subsequent second inner gas cooling conduit 1902 lies within the first inner conduit 1901 and similarly, a third inner conduit 1903 is nested within the second inner conduit and a fourth inner conduit 1904 is nested within the third inner conduit and laying parallel thereto.

Each conduit is connected by a substantially semicircular portion (the return section), which connects the two substantially parallel arms of the conduit, so that at the return end of the cooler, a plurality of substantially semi circular conduits are co-axially nested within each other, within a main plane of the cooling plate.

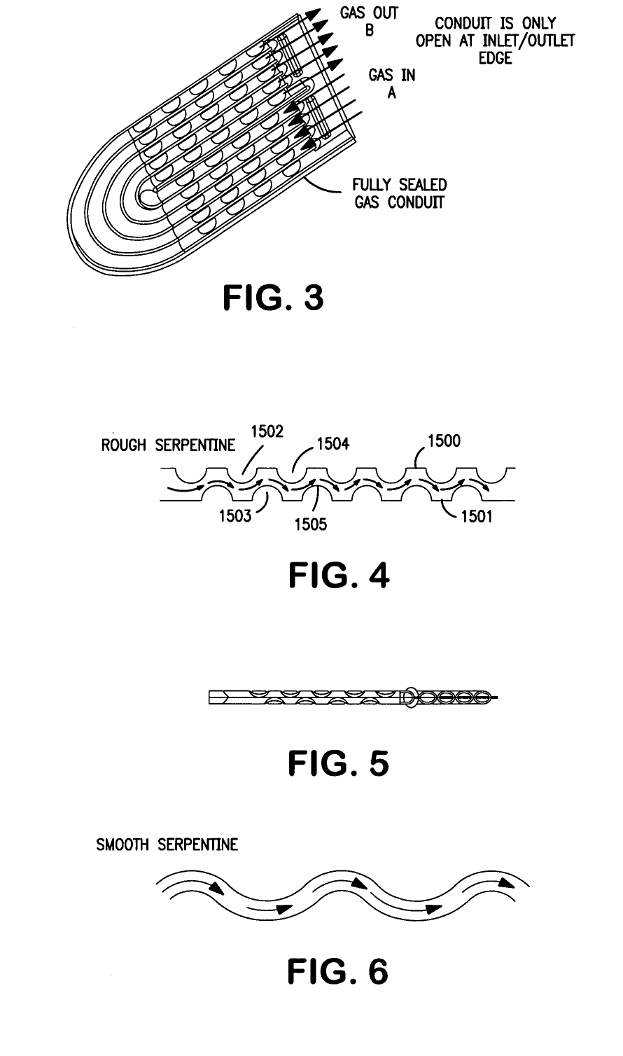

Referring to FIG. 9 herein, there is illustrated schematically in cutaway view from above, the U shaped cooler of FIGS. 1 to 3, showing a plurality of five parallel cooling plates 2000-2004 arranged side by side and in parallel, surrounded by coolant fluid 1506. Also shown is an adaptor 2005, which forms part of the canister, having first and second apertures 2006, 2997 for inlet and outlet of coolant fluid.

Coolant enters the canister/adaptor 2005 via an inlet aperture 2006 and exits the canister via an outlet aperture 2007 in the adaptor.

Internally, the central cooling plate 2002, along the straight portion of the canister, before the semicircular end portion, may be slightly wider and closer fitting to the insider of the canister, than the other coolant plates 2000, 2001, 2003, 2004, so that the central cooling plate provides a division wall between one half of the internal cavity and another. Alternatively, spacers 1304, 1305, respectively, may fulfill this function. Alternatively, canister 2008 and adaptor 2005 may have a form that fulfills this function. Coolant flows in the direction showed arrowed within the canister, along one side of the canister, around the central cooling plate 2002 at the end of the canister in a semi circular portion, and back following a return path along the other side of the canister on the other side of the central cooling plate 2002. Within each half of the canister, coolant fluid can flow over the top of each coolant plate between the coolant plate and the canister, or underneath the coolant plate, along the length of the canister. The central cooling plate 2002 is manufactured to have dimensions such that there is a slight gap between the edges of the coolant plate and the canister, to avoid thermal stresses between the canister and the cooling plate during heating and cooling of the device, but this gap is not sufficient to significantly affect the passage of fluid through that gap, and so that the main fluid flow is along the length of the canister, to the semi-cylindrical end, and following a return path on the opposite side of the central cooling plate 2002. This promotes flow of coolant fluid around each side of each cooling plate, and avoids short cuts for fluid flow between the coolant inlet and the coolant outlet.

Referring to FIG. 4 herein, there is illustrated schematically in cross-sectional cutaway view, a portion of a single conduit within a single cooling plate. A flow of gas within the conduit is shown arrowed. Each conduit channel is substantially tubular, being formed between an upper plate wall 1500, and a lower plate wall 1501. A normally cylindrical or approximately cylindrical tube is modified to provide a serpentine, meandering flow path, by the formation of a plurality of indents 1502, 1503, 1504 and 1505, formed in the walls of the coolant plate. Alternatively, an upper plate wall 1500, and a lower plate wall 1501, may be formed separately and joined together whether by brazing, soldering or welding. A plurality of indents 1502, 1504, on an upper wall of the coolant plate, are alternated with a plurality of indents 1503, 1505 on the lower wall of the coolant plate, so that the gas flows through the conduit, alternating between a first wall of the cooling plate and a second wall of the cooling plate, inside the conduit. Each indent forms a scallop-like shape, being an elongate ovoid concave impression in the form of an elongate crater or scoop shape. The provision of the indents will slightly impede the flow of gas through the conduits, since it breaks up the laminar flow of gas and causes turbulent behavior, mixing the gas, and thereby ensuring that there is more mixing of the gas and therefore hotter portions of the gas flow also swirl around to contact the cooler side walls of the cooling plate.

Referring to FIG. 5, there is illustrated a further specific mode of the design.

Referring to FIG. 6 herein, there is illustrated a second and alternative shape for a conduit within a cooling plate, in which the walls of the gas conduit form a smooth serpentine path. The walls of the conduit may be formed to provide a substantially smooth tubular shape which has substantially circular cross-section in a direction perpendicular to a main center line of the conduit, and which follows a substantially sinusoidal path. A gas conduit of this shape may provide less disruption and turbulence, and therefore less resistance to flow, than a shape as shown in FIGS. 4 and 5 herein but, at the penalty of perhaps achieving a lower amount of mixing of the central gas flow in the conduit, with the boundary gas flow which touches the upper and lower walls of the conduit.

It will be appreciated by those skilled in the art that different variations of conduit interior shape are possible, and different shapes will trade off mixing of the gas flow and creation of turbulence, which slows down the gas flow, with sufficient contact with the side walls of the cooling plate, to promote cooling of the gas flow.

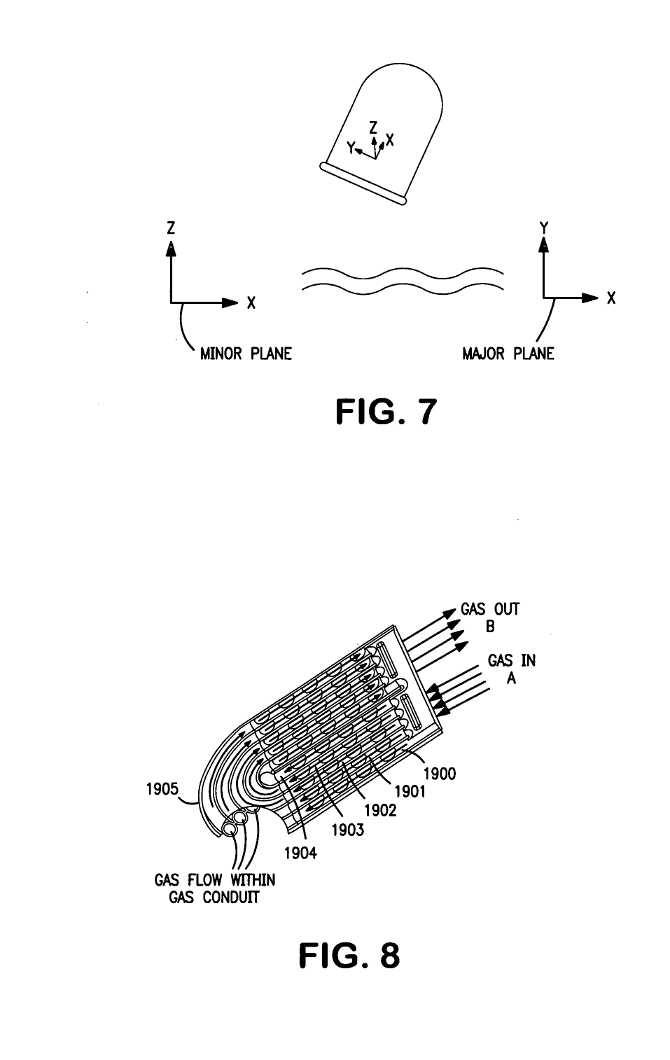

Referring to FIG. 7 herein, there is illustrated schematically that the serpentine form, either rough or smooth, may be formed in either substantially on the major plane of the wall (X, Y), or alternatively, substantially on the minor plane of the wall (X, Y).

Referring to FIG. 8 herein, there is illustrated schematically in perspective view from one end and one side, directions of gas flow within a single cooling plate. Gas can flow in three dimensions, along a length of the cooling plate, along the conduits, across an internal width of the cooling plate, and across the plate, from conduit to conduit, since the conduits are not necessarily fully gas sealed with respect to each other, and inter conduit gas flow to a limited extent may occur. In all cases, the gas flow is contained within the conduit, and gas can only enter or exit the conduit at one end 1900.

Referring to FIG. 7, gas can flow in three orthogonal directions, with a predominant flow of gas being in a direction along the conduit, with subsidiary gas flow directions being in directions orthogonal to a main gas flow (in an Y direction). Within an individual conduit, gas can follow a serpentine path, a complex turbulent flow path, and individual gas molecules can move in three dimensions within the conduit, following a plurality of swirling, spiraling, linear or other individual paths which bring the gas molecules into contact with the side walls 1900, 1901 of the cooling plate.

Referring to FIG. 9 herein, there is illustrated schematically an embodiment of a cooling device comprising five individual parallel cooling plates, shown here in partially assembled view, without the external canister, and showing flows of coolant around the cooling plates.

Coolant enters the assembly at the coolant inlet port 2006, and exits the assembly at the coolant outlet port 2007. Clearly shown on the exterior of an outer cooling plate 2000 are a plurality of scallop-shaped indents 2009. Also shown for a central cooling plate is a recess 2010 in adaptor 2005, which is followed on the canister 2008 until the end of the parallel section of the cooling plate, which, in conjunction with the center most gas cooling plate, inhibits the passage of coolant from one side of the canister to another, and forces significant flow of coolant fluid around the ends of the cooling plates as shown in FIG. 9.

Although in FIG. 9, the semicircular portions of the conduits are shown without indents, and as smooth semi-toroidal channels, in a further embodiment, indents may be pressed into the conduit walls all the way around the semi circular portions, to increase the surface area of coolant wall which the gas encounters on passing through the conduits, and to increase the mixing of the gas flow within the conduits.

Referring to FIG. 8, for each cooling plate, the plate comprises a sealed envelope, which is gas tight, with the perimeter 205 of each cooling plate being sealed by welding or brazing at the far end 1905, and in the case of the cooling plate being constructed from two separate walls 16000 and 1601, also sealed by welding or brazing on each side.

Referring to FIGS. 10 to 12 herein, there is illustrated schematically a method of manufacture of one or more individual cooling plates as described herein before.

Referring to FIG. 10, a length of annular cylindrical metal tube is used as the basis for forming one or a plurality of cooling plates. This may have an advantage that more than one cooling plate can be formed in a single operation, and two of the edges of each cooling plate require no brazing or welding in order to make them gas tight.

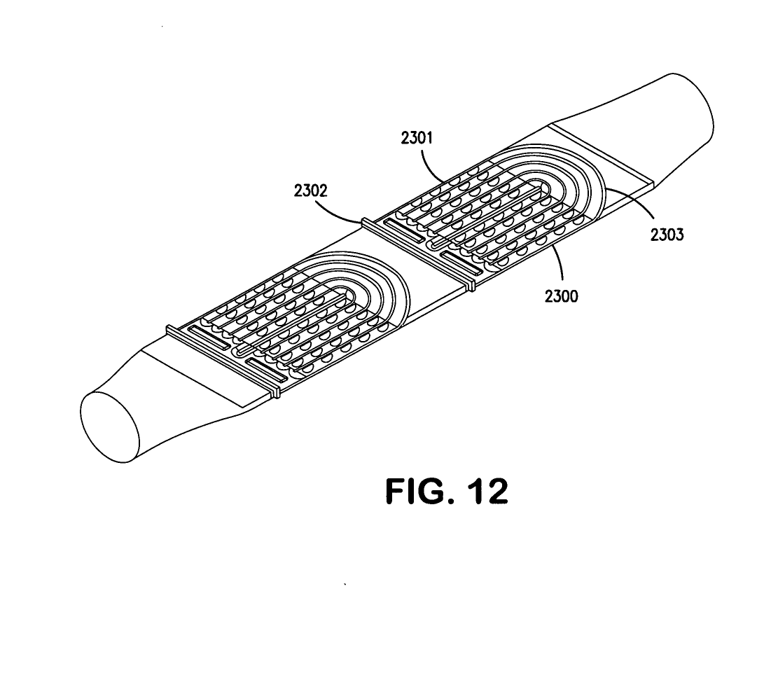

Referring to FIG. 12 herein, the tube is pressed using a pressing tool, which is shaped so as to press the sides of the metal tube into the plurality of conduits including scallop shaped indents in a single operation. The pressing tool is not shown to assist clarity of the figure. To avoid the tube collapsing in on itself, the tube may be pressurized with hydraulic fluid during the pressing operation.

Alternatively the process may be a two step process. A first part of the process would be to press the round tube down to a flattened tube. A second part of the process is to hydroform the tube up into a forming tool that gives the required final form.

Referring to FIG. 11, there is illustrated the first part of the process where the round tube is flattened down.

Referring to FIG. 12, there is illustrated schematically in view from above the finished pressed tube having formed therein, in this case, a pair of individual cooling plates. It will be appreciated by the person skilled in the art that a longer length of tube may be used to press out three, four or any other number of required cooling plates, depending upon the length of tube and the length of the pressing tool.

Once formed, a plurality of cooling plates are provided in a single tube. The cooling plates are then cut from each other, and any excess metal is cut using an appropriate method of cutting.

In variations of the manufacture method, the pressing/forming tool may also serve to press and cut the tube in a single or substantially single forming operation.

Once the cooling plates are separated from each other, the first and second edges 2300, 2301 respectively are already sealed, since they are formed from the sides of the tube. However, the ends of the cooling plate 2302 and 2303 remain open, corresponding with the cut ends of the tube. Whilst the open end 2302 remains open, since this forms the gas inlet and the gas outlet, the other end of the tube 2303 needs to be sealed. Since the first and second sides of the cooling plate meet each other at their semicircular end 2303, they may need to be welded or brazed in order to make a gas tight seal.

In other variations of the manufacturing process, the end 2303 of the cooling plate can be pressed together to form a gas tight seal in a single operation or substantially single operation, under pressure of the tool.

In another construction method, each individual gas conduit may be attached to a carrier to form a leak tight seal between a cooled gas conduit and a carrier. Preferably, a stack of carriers are housed within an adapter and the carriers are brazed to each other and the adapter in order to form a leak tight seal. Alternatively, the carriers may be welded to each other and to the adapter to form a leak tight seal.

The complex form on the cooled gas carrier comprises a number of main gas flow paths. Preferably each main gas flow path is formed as close to its adjacent main gas flow path as the process tooling will allow. However, the spacing between adjacent main gas flows can be increased in order to increase tooling robustness.

Formed into each main gas flow path are features, which inhibit the formation of a gas boundary layer and which promote bulk mixing of the gas during its flow through the cooler. Preferably, such features may comprise a series of scallop-shaped formations arranged on either side of the cooled gas conduit, such that a serpentine like path is formed in each conduit.

Alternatively, the feature can be formed to give a smooth serpentine form.

Preferably, the serpentine form will run along a minor axis of the gas conduit. In other embodiments, the serpentine form may run along a major axis of the conduit. In various embodiments, the serpentine form may run in the return section of the cooler and in other embodiments, the return section of the cooler may have a smooth non serpentine gas flow path.

Alternatively, instead of a rough or smooth serpentine form to promote gas mixing, a notch feature may be used.

Preferably, a profile for the cooled gas conduit also forms, on its outer skin, an undulating flow path for the coolant. Thus the cooled gas conduit can be stacked in very close proximity to each other.

A section between main gas paths, which are flowing in the same direction, does not necessarily close completely. A small amount of flow between gas paths is encouraged in order to promote gas flow over every section of the cooled gas conduit wall.

Alternatively, in other embodiments the section can have nominal contact.

Preferably the section between main gas paths, which are flowing in opposite directions, should promote the exclusion of gas flow between those paths. This exclusion may be promoted by a designed nominal contact between adjacent plates.

In an alternative modification, the section may be attached together, preferably by welding, or brazing. This design requires a greater separation of the main gas paths.

In a preferred embodiment, each cooled gas conduit may have a wall thickness between 0.1 mm and 1.0 mm.

The assembly may comprise a combination of materials. Preferably the following materials may be used:

austenitic stainless steel

ferritic stainless steel

copper

copper alloy

nickel

nickel alloy

a plastics material (for components not in direct contact with the gas).

A modular channel U shaped cooler may be brazed in a single pass during manufacture. Alternatively, other than the sealing of the individual cooled gas conduits, the device may be welded as a single station. Since all the joints, other than the sealing of the individual cooled gas conduits, are external to the assembly, this may have the advantage of enabling brazing in a single operation, or welding in a single operation.

A cooler device as disclosed herein may have the following advantages.

Heat exchange is maximized by the following mechanisms.

Formation of the gas boundary layer is continuously inhibited, thus increasing the heat transfer co-efficient.

Eliminating core flow paths in the gas cooling conduit by continuous bulk mixing of cooled gas with uncooled gas promotes a hotter gas near to the heat exchange surface.

Maximizing the heat exchange surface area within a given volume promotes efficient heat transfer from a plate cooling surface to the gas.

Overall size reduction is achieved by the following features.

The utilization of closely packed gas cooling conduits increases the relative heat transfer per volume unit.

Volume is reduced by eliminating the need to have a method of transferring coolant from one coolant conduit to another, by having only one coolant conduit.

Gas pressure drop is minimized by the following features.

The utilization of closely packed gas cooling conduits thus allowing more cooling conduits to be designed into the same space minimises the pressure drop across the device.

Because the gas cooling conduits provide a controlled path for the return part of the cooler, this also helps to minimize the gas pressure drop across the device.

Robustness of the device is enhanced by the following features.

The gas cool conduits are hard interfaced with other components only at one edge, i.e. at the inlet/outlet interface. Therefore, any thermal expansion of the conduit is into unrestricted free space thus reducing thermal stresses.

By only interfacing the gas cooling conduit at one edge, this facilitates the flow of coolant around all of the volume of the cooling plates. Thus, it can be ensured that adequate coolant flow is generated all over the heat exchange surfaces. Further, there are no complicated and potentially costly channels required to join individual coolant conduits.

The number and length of joints is significantly reduced from that compared to prior art plate coolers, making the design inherently more robust.

Ease of manufacture and cost competitiveness is promoted by the following features.

A comparatively reduced amount of material can be used compared to prior art coolers of comparable specification, because the reduced thermal stresses allow thinner wall materials to be used.

A reduced amount of material can be used because the reduced length and number of joints allow less braze paste to be used.

The device has all of its brazed joints accessible externally. Thus, only a single pass through a brazing furnace or oven is required, enhancing ease of manufacture and reliability.

The gas conduits are all provided as a sealed unit. Thus, each gas conduit can be leak tested prior to assembly into a fully assembled cooler device.

Because each gas cooling conduit is modular in design, heat exchangers of different capacities can be made from the same modular conduit by either adding or subtracting cooling conduits per device. Thus, manufacturing tooling costs are reduced over a range of gas cooling device products.

The modular channeled U shaped cooler interfaces with a gas circuit, usually an exhaust gas re-circulation bypass valve, at a single interface plane.

The individual cooled gas conduit may be manufactured from a flattened tube, onto which a complex profile is formed. The tube is then sealed at a return end, to form a leak tight gas path. Alternatively, the cooled gas conduit may be manufactured from two separate plates, onto which a complex profile is formed, for example by stamping. The plates are then sealed together at a top and bottom end, and a return end, to form a leak tight gas path.

A sealing method for either the tube or the plates, is welding. Alternatively, brazing may be used.

The complex profile may be formed onto the flattened tube or the plates by a hydro forming process. Alternatively, a pressing process may be used.

The stack of gas conduits may be housed within an adapter and the gas conduits brazed to each other, and the adapter, to form a leak tight seal. Alternatively, the gas conduits may be welded to each other and to the adapter to form a leak tight seal.

1. An exhaust gas re-circulation cooler device comprising:
at least one cooling plate, said cooling plate comprising:
an upper plate wall and a lower plate wall said upper and lower plate walls defining a plurality of gas passages which have a gas inlet at a first end of cooling plate and a gas outlet at said first end of said cooling plate;
each said passage directing a gas flow between said inlet and said outlet and around a length of said plate;
said plate being sealed so as to be gas tight along a length of said plate, and at a second end of said plate.

2. The cooler device as claimed in claim 1, wherein a plurality of said gas passages are nested concentrically within each other in a main plane of the cooling plate.

3. The cooler device as claimed in claim 1, wherein said plurality of gas passages are isolated from each other.

4. The cooler device as claimed in claim 1, wherein said plurality of gas passages are partially isolated from each other, wherein a main flow of gas passes along a main length of each said gas passage, but a restricted passage of gas between adjacent gas passages within a same cooling plate is also provided for.

5. The cooling plate as claimed in claim 1, comprising a plurality of indents arranged along said plurality of gas conduits, said plurality of indents extending into said gas passages, for distributing a flow of gas passing through said passages and thereby creating a mixing of gas flow within one or more said gas passages.

6. The cooler device as claimed in claim 1, wherein said gas passages are arranged such that gas flows in an alternating serpentine path along a length of each of said gas passage.

7. The cooler device as claimed in claim 1, wherein each said gas passage comprises a substantially “U” shaped tubular passage.

8. The cooler device as claimed in claim 1, comprising a plurality of said cooling plates stacked side by side, said plurality of cooling plates connected at their respective first ends, such that a plurality of inlets to said plurality of cooling plates lay adjacent each other, and a plurality of outlets of said cooling plates lay adjacent each other.

9. The cooler device as claimed in claim 1, wherein a plurality of said cooling plates are arranged side by side, spaced apart from each other such that a coolant fluid can pass between said plurality of cooling plates.

10. The cooler device as claimed in claim 1, comprising a plurality of cooling plates arranged side by side in parallel to each other, and further comprising an external canister surrounding said plurality of cooling plates, the arrangement being that coolant fluid flows into said canister via a coolant inlet port, around said plurality of cooling plates, and out of a coolant outlet port of said canister.

11. The cooler device as claimed in claim 1, wherein each said cooling plate is of a substantially “U” shape and a plurality of said cooling plates are stacked side by side within an external canister.

12. The cooler device as claimed in claim 1, further comprising a tubular passage, which encloses one or a plurality of gas passage inlets and one or a plurality of gas passage outlets, said passage containing a bypass valve for directing a gas flow into said plurality of inlets, or alternatively directing said gas flow past said plurality of inlets and outlets.

13. The cooler device as claimed in claim 1, comprising a plurality of cooling plates arranged side by side in a canister, wherein said plates are arranged such that a coolant flow within said canister passes along a main length of each said cooling plate between a first end and a second end of each said plate, and around a second end of each said cooling plate.

14. The cooler device as claimed in claim 13, wherein a centrally disposed cooling plate serves to divide a coolant flow into an outgoing and flow towards said second end of said canister and a return coolant flow from said second end back to said first end of said canister.

15. The cooler device as claimed in claim 14, wherein said plurality of cooling plates are connected at their first ends, so as to be suspended within a main cavity of said canister, such that coolant may flow between an upper and/or lower outer periphery of at least one said cooling plate and an outer wall of said canister, and between chambers defined between individual ones of said cooling plates.

16. The cooler device as claimed in claim 1, wherein thermal growth of the cooling plates is accommodated in a plane parallel to a main plane of said cooling plate.

17. A cooling plate for a cooling device, said cooling plate comprising:
a first side wall and a second side wall, said first and second side walls being spaced apart from each other;
said first and second side walls connected at an upper and a lower portion;
said cooling plate having a first end comprising one or a plurality of openings for entry of a gas, and a second end, which is closed off;
a plurality of gas conduits, arranged side by side, each gas conduit extending from an inlet portion at the first end of the plate, to an outlet portion at said first end of the plate.

18. The cooling plate as claimed in claim 17, wherein each said gas conduit is physically isolated from each other said conduit by a gas tight seal.

19. The cooling plate as claimed in claim 17, wherein each said gas conduit is partially isolated from an adjacent other said gas conduit, such that a leakage of gas from one gas conduit to another may occur.

20. The cooling plate as claimed in claim 17, wherein each said gas passage is isolated form each other said gas passage, so that gas flowing in one passage cannot transfer to another passage.

21. The cooling plate as claimed in claim 17, comprising a plurality of indents arranged along said plurality of gas conduits, said plurality of indents extending into a passage of each said gas conduit, for disturbing a flow of gas passing through said conduit and thereby creating a mixing of flow within one or more said gas conduits.

22. The cooling plate as claimed in claim 17, comprising a plurality of indents, which protrude into internal gas passages of said plurality of conduits, so that gas flowing through a said conduit follows a serpentine like path through said conduit.

23. The cooling plate as claimed in claim 17, wherein said first and second side walls are formed from a tube which is pressed or stamped together, and which is closed off at said second end.

24. The cooling plate as claimed in claim 17, wherein said first and second side walls are positioned opposite each other with said plurality of gas conduits formed there between, each of said first and second side walls having a substantially rectangular shape having a semicircular portion at said second end, where the rectangular portion and the semicircular portion are substantially in a same plane.

25. The cooling plate as claimed in claim 17, in which thermal growth is accommodated within a main plane of a said gas passage.

26. A method of manufacture of a cooling plate for a gas cooling device, said method comprising:
forming first and second opposed sides spaced apart form each other, wherein said first and second sides define a plurality of gas conduits arranged side by side between said first and second sides, each said gas conduit extending from an inlet portion at a first end of said cooling plate to an outlet portion at said second end of said cooling plate; and
sealing said first and second sides at a second end, opposite to said first end, to form a gas tight seal between said first and second sides.

27. The method as claimed in claim 25, comprising sealing said first and second sides such that gas can only enter or exit said cooling plate at said first end.

28. The method as claimed in claim 25, comprising pressing a single metal tube component to form said first and second sides, and sealing said second end of said tube.

29. The method as claimed in claim 25, comprising hydro forming said first and second sides.

30. A method of manufacture of a cooling device, said cooling device comprising:
at least one cooling plate, said cooling plate comprising:
an upper plate wall and a lower plate wall
said upper and lower plate walls defining a plurality of gas passages which have a gas inlet at a first end of cooling plate and a gas outlet at said first end of said cooling plate;
each said passage directing a gas flow between said inlet and said outlet and around a length of said plate;
said plate being sealed so as to be gas tight along a length of said plate, and at a second end of said plate; and
an outer canister for containing said at least one cooling plate, and for containing a flow of coolant fluid around said at least one cooling plate,
said method comprising:
inserting said cooling plate into said canister such that one or a plurality of gas inlet ports and one or a plurality of gas outlet ports positioned at a first end of said cooling plate are positioned at a first end of said canister; and
connecting said first end of said cooling plate to said first end of said canister such that said gas passages are contained within said canister and said plurality gas inlets and gas outlets are accessible at said first end of said canister.

31. The method as claimed in claim 30, wherein a first end of said cooling plate is connected to a first end of said canister by welding, brazing or soldering.

32. The method as claimed in claim 30, comprising inserting a plurality of cooling plates side by side in said canister such that said cooling plates lie spaced apart from each other throughout a length of said canister and are connected together at a first end of each said cooling plate at a first end of said canister.

33. The method as claimed in claim 32, wherein first ends of said plurality of cooling plates are connected together and to a first end of said canister in a single brazing, soldering or welding operation.

34. An exhaust gas re-circulation cooler device comprising:
at least one cooling plate, said cooling plate comprising:
first and second walls;
said first and second walls defining a plurality of gas passages which have a gas inlet at a first end of said cooling plate and a gas outlet at said first end of said cooling plate;
each said passage directing a gas flow between said inlet and said outlet and along a length of said plate;
said plate being sealed so as to be gas tight along a length of said plate, and at a second end of said plate,
wherein thermal growth of said cooling plate is accommodated predominantly in a plane of the gas passages.
